(19) United States
(12) Patent Application Publication
(10) Pub. No.: US 2016/0275224 A1
(43) Pub. Date: Sep. 22, 2016

(54) APPARATUS AND METHOD FOR GENERATING A REDUCED NUMBER OF TEST VECTORS AND INSERTING TEST POINTS FOR A LOGIC CIRCUIT

(71) Applicants: Arani Sinha, Hillsboro, OR (US); Sandip Ray, Beaverton, OR (US)

(72) Inventors: Arani Sinha, Hillsboro, OR (US); Sandip Ray, Beaverton, OR (US)

(21) Appl. No.: 14/664,749

(22) Filed: Mar. 20, 2015

(51) Int. Cl. G06F 17/50

(52) U.S. Cl. CPC G06F 17/5045

(57) ABSTRACT

A method is described that includes performing the following by executing program code on a computing system. Generating an expression describing the operation of an electronic circuit for each of a plurality of faults within the circuit. Generating a plurality of fault equations for each of the faults that compare output bits of a faulty circuit with output bits of a working circuit. Combining the fault equations into a conjunctive logical expression. Attempting to solve a problem posed by the conjunctive logical expression with a MAXSAT solver to generate a test vector for the electronic circuit.

### FIELD OF INVENTION

The field of invention pertains generally to semiconductor circuit design, and, more specifically, to an apparatus and method for generating a reduced number of test vectors and inserting test points for a logic circuit.

### BACKGROUND

With continued transistor size reductions the numbers of transistors that can be integrated in a particular logic circuit design continues to grow. A set of test vectors is typically used to test a circuit design that has been manufactured into a semiconductor chip. Here, the set of test vectors is physically applied to the inputs of the circuit with the chip and any output of the chip that corresponds to an “incorrect” output (e.g., as compared against a test output vector) is flagged and the circuit is recognized as faulty. A problem is that with the increased size and complexity of logic designs, the corresponding set of test vectors is also becoming increasingly large. Also, in some cases, a fault is such that it cannot be tested in the circuit when test vectors are applied only at the inputs. As such, it would be prudent to have a test vector generation mechanism that yielded a reduced number of input test vectors

### FIGURES

The present invention is illustrated by way of example and not limitation in the figures of the accompanying drawings, in which like references indicate similar elements and in which:

FIG. 1 shows an improved test vector generation method;

FIG. 2 shows a methodology for generating expressions representing faults of a circuit;

FIG. 3 shows a computing environment in which the methodologies of FIGS. 1 and 2 may be practiced.

### DETAILED DESCRIPTION

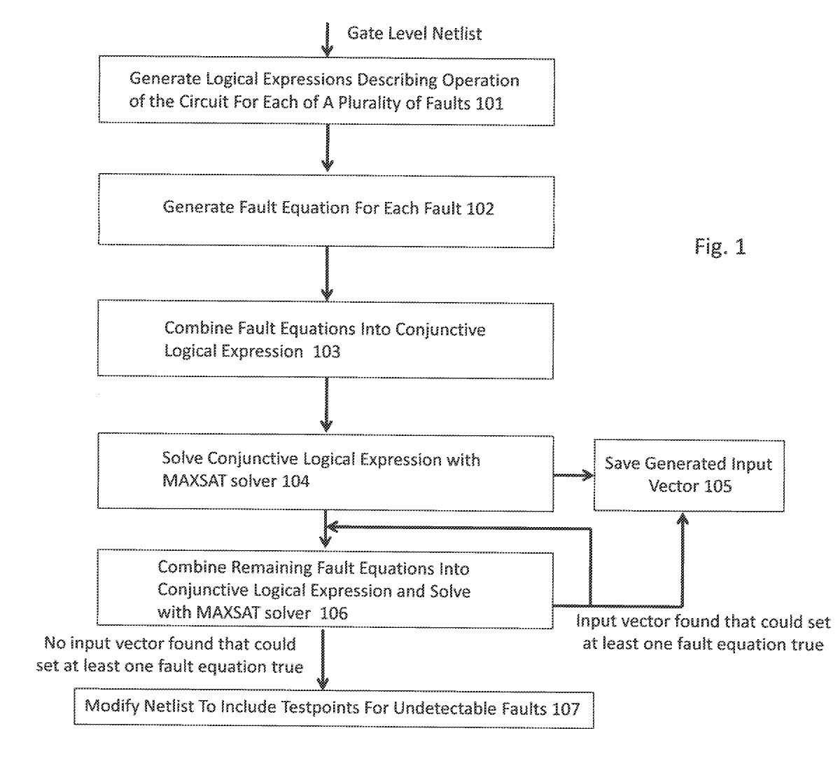

FIG. 1 shows an improved test pattern generation sequence that attempts to generate a test pattern that is specifically designed to maximize the number of faults that can be detected from the test pattern. As will be described at length below, the approach of FIG. 1 expresses the logical equations of a logic circuit design in a special mathematical format that permits the problem posed by the expression to be presented to a MAXSAT problem solver. MAXSAT is a known mathematical problem solving technique that tries to find an input vector that can set every term in a conjunctive logical AND equation equal to a logical “true”. The specially formatted mathematical expression that is created by the sequence described herein expresses the faults of the logic circuit with logical equations that describe the logic circuit having the fault.

These expressions are then combined into a conjunctive logical form such that each term in the conjunctive logical form corresponds to a different fault. The MAXSAT solver then tries to find an input vector that will cause every term to be true, which, in turn, corresponds to an attempt to generate an input vector that will detect every fault should it exist and be detectable. Importantly, the MAXSAT solving process automatically generates test vectors that will reveal a theoretically maximal number of faults that can be detected with a single test vector. As such, the set of test vectors generated for a single circuit should be closer to the theoretical minimum resulting is smaller overall test footprint for the circuit.

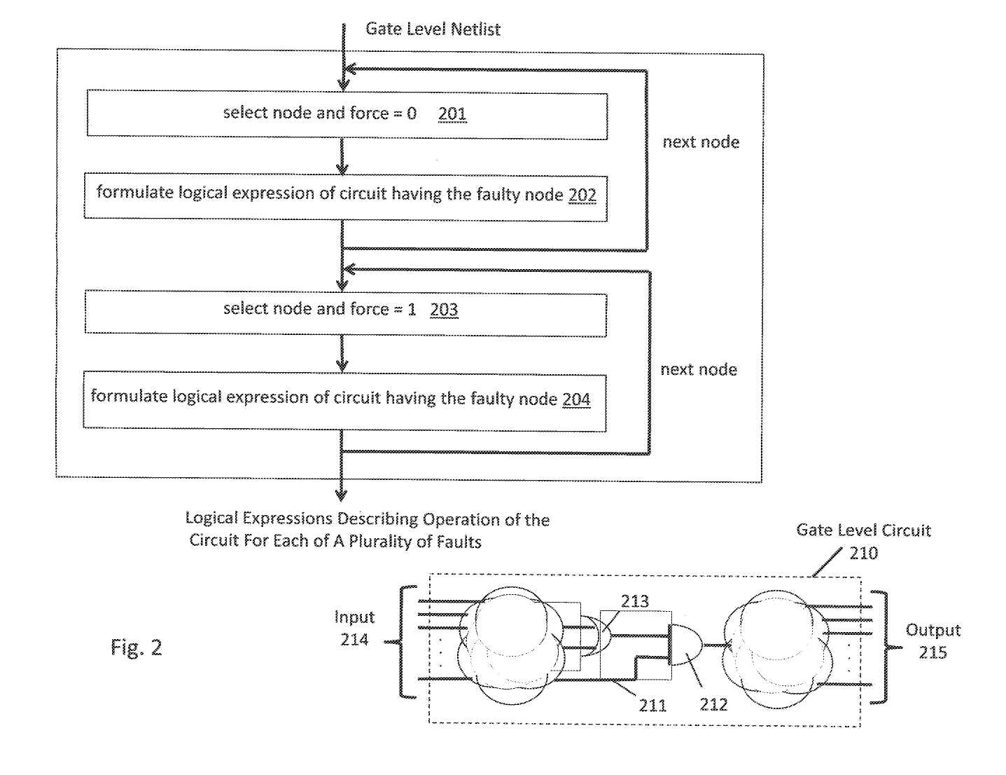

FIG. 1 shows an embodiment of the test pattern generation process. Initially, a gate level netlist is analyzed and logical expressions are generated for the circuit for each fault that is being tested for 101. FIG. 2 shows an embodiment 200 of the analysis that is performed by process 101 of FIG. 1.

FIG. 2 shows portions of a logical circuit at inset 210. One type of test that can be tested for is “stuck-at-0”. In the case of a stuck-at-0 fault a node of the logical circuit that is defective is logically forced to 0. For example, assume node 211 is selected and set equal to 0. The effect of forcing node 211 to zero will clearly force the output of AND gate 212 equal to zero irrespective of the output of OR gate 213. The setting of node 211 to zero may therefore effect the output value produced by the circuit at output 215 as compared to a correctly working circuit. That is, for a same input vector presented at the input 214 of the circuit 210, the output values presented at the output 215 of the circuit 210 may be different if node 211 is forced to zero as compared to when the circuit 210 is working properly and node 211 is free to be controlled by whatever gate is driving it.

If so, a “testable” fault of the circuit is having node 211 stuck at zero. Here, the setting of node 211 to zero effectively created a different logical operation of the circuit 210 as compared to the logical operation of the circuit 210 when it is working properly. Here, the two different logical operations can be expressed literally with two different mathematical logical expressions. That is, the logical operation of the improperly working circuit will always have a logical zero at the input of whatever gate AND gate 212 is driving. This corresponds to a different mathematical expression of the circuit than the properly working circuit (where the input of whatever gate AND gate 212 is driving is a function the output of OR gate 213 and the output of whatever gate is driving node 211).

Thus as seen in the process of FIG. 2, a node of the gate level netlist is selected and forced equal to zero to simulate a fault at that node 201. A logical expression that represents the operation of the circuit with the fault is then formulated 202. Note that the logical expression of the circuit with the fault will accept an input vector at input 214 and will generate an output at output 215.

The process then repeats for every node in the circuit 202. As such, a logic expression is formulated for every node in the circuit when that node is set to zero. The entire process then repeats again 203, 204 but where each node is set to one rather than zero. As such, in an embodiment, at the end of the process of FIG. 2 there are 2K logical expressions where K is the number of nodes in the circuit. Here there are two expressions for each node in the circuit, one expression for when a particular node is set to zero and a second expression for when the same node is set to one.

Notably, in an embodiment it may not be known which of the 2K faults represented by the 2K expressions are testable. That is, it is not known yet which of these expressions will yield a different output value than what an expression of the working circuit will yield when the pair of expressions are provided a same input test vector. For simplicity FIG. 2 and its discussion only contemplated stuck-at-0 and stuck-at-1 faults. Further below embodiments for accommodating the existence of transitional errors are also discussed.

Referring to FIG. 1, after the 2K expressions of a faulty circuit are formulated 101, each of these expressions is formulated as a conjunctive logical comparative expression with the expression for the working circuit. That is, a conjunctive logical comparative expression (referred to as a “fault equation”) is generated for each potential fault in the circuit 102.

In an embodiment, the expression for each output bit of a faulty circuit having a specific node stuck at a 1 or 0 is compared (XORed) against that same output bit for a working circuit. Said another way, if f(v) represents the logical expression for the working circuit which produces n output bits in response to an input vector v, then there are n expressions for f(v), fᵢ(v) where i=1 ton, where each unique fᵢ(v) corresponds to a different output bit of f(v). The same concept can be extended for the expression for the faulty circuit which can be labeled f*(v). Here, if f*(v) represents the logical expression for a faulty circuit having a particular node stuck at a particular logic value that produces n output bits in response to an input vector v, then there are n expressions for f*(v), fᵢ*(v) where i=1 to n, where each unique fᵢ*(v) corresponds to a different output bit of f*(v).

As such, a “fault equation” for the specific fault (the specific node being stuck at the particular logical value) can be expressed as:

Pₖ(v)=(f₁(v)XOR f₁*(v))OR(f₂(v)XOR f₂*(v))OR(f₃(v)XOR f₃*(v))OR . . . ((fₙ(v)XOR fₙ*(v)) Eqn. 1.

Here, Pₖ=1 if the value of any output bit of the working circuit differs from the value of the same output bit of the faulty circuit when a same input vector v is provided to both circuits. Thus, “fault equation” Pₖ is an expression that will equal 1 for a particular input vector v if the fault that Pₖ represents is testable with vector v. As observed in FIG. 1, process 102 generates a fault equation for all 2K faults of the circuit. That is k=1 to 2K referring to the formulation “Pₖ(v)” in Eqn. 1.

Referring to FIG. 1, the set of 2K fault equations are then expressed in a singular conjunctive logical expression 103. For example, in an embodiment, the following expression is formulated:

Clausal MAXSAT of circuit=P₁(v)AND P₂(v)AND P₃(v)AND . . . AND P2K(v) Eqn. 2.

Here, the above equation is a conjuctive logical AND of each of the fault equations. A MAXSAT problem solver is a solver that will attempt to find “a solution” to a conjuctive logical AND expression by finding an input vector v for which every term in the expression (every Pᵢ(v) above) is true. This means with the formulation above in Eqn. 2, a MAXSAT problem solver can potentially find a single input vector v that will demonstrate the existence of any fault in the circuit should it exist. In this sense, the present approach is potentially maximally efficient because only a single input test vector would need to be applied to a circuit that will reveal the existence of all possible faults in the circuit should any such possible faults actually exist within the circuit. In case each of the Pi(v) clauses is not satisfiable, then the maximum number of clauses that are simultaneously satisfiable will be identified.

The expression above in Eqn. 2 is labeled as “Clausal MAXSAT” because it actually does not technically conform to the conjunctive logical AND format that a MAXSAT problem solver is designed to solve. More specifically, a standard MAXSAT problem solver will solve a conjunctive logical AND expression having each of its individual terms (Pᵢ(v)) also expressed as a conjuctive logical AND expression. By contrast, the terms of a fault equation Pᵢ(v) as expressed in Eqn. 1 are expressed with logical XOR functions and not logical AND functions. However, with straightforward application of #-P-complete reduction techniques, the above Clausal MAXSAT expression can be readily reduced, e.g., to a true conjuctive AND form.

As observed in FIG. 1 a MAXSAT problem solver then attempts to solve the problem posed by the Clausal MAXSAT expression 104. MAXSAT problem solvers are generally available from commercial vendors as software applications that can execute on a server, work station or other computing system.

In an ideal scenario, the MAXSAT problem solver finds an input test vector v that completely solves the problem in which case, a single test vector will be generated that will reveal the existence of all possible stuck-at faults should any exist in the circuit. Practically speaking however there are bound to be logical circuits for which a single test vector will not be able to reveal all possible faults. If not, nevertheless, the MAXSAT problem solver will at least provide the closest test vector it could find which will correspond to a single test vector that causes the maximum possible number of fault equations Pᵢ(v) to be true. For example, if 2K=150,000, the first pass attempt made by the MAXSAT problem solver may generate a single test vector that will set 125,000 of the 150,000 different fault equations to be true if any of their corresponding faults actually exist.

As such, the test vector is saved 105 as a first test vector created in the set of test vectors that will be created for the circuit. A new conjunctive AND expression is then created 106 that only includes the fault equation terms that the MAXSAT problem solver's previous generated input vector could not set to true. For example, if the first pass of the MAXSAT problem solver generated an input vector that could set all fault equations of k=4 to 2K equal to one, then the new Clausal MAXSAT conjunctive AND expression would only include the fault equations for k=1, 2 and 3. The MAXSAT problem would then attempt to solve the problem posed by the new expression 106. The process iterates, saving a new test vector 105 each time a newly generated test vector is found that will set at least one fault equation in its conjunctive AND expression to true. It is again worth noting, however, that the MAXSAT problem solver tries to find an input vector that will set a maximum possible number of fault equations to true. Therefore, the overall process is expected to generate a minimal number of test patterns.

The process ends when a set of test vectors has been generated that will set the fault equations for all detectable faults to true. The existence of one or more undetectable faults is possible. Here, a set of test patterns will typically have been generated and saved and only the fault equations for the undetectable faults remain in the Clausal MAXSAT expression. When the MAXSAT problem solver attempts to find a solution to the problem posed by this Clausal MAXSAT equation it will not be able to find a single test vector that will cause any of the fault expressions to be set to true. Upon this event, the set of undetectable faults are recognized and the gate level netlist is modified 107 to insert test points directly at the nodes that the undetectable fault expressions correspond to.

Note that for each test vector that is generated, an “output” test vector can also be generated by applying the generated input test vector to the working circuit logic expressions and determining what the output of the circuit in response to the input vector should be. Any generated output vector should also be saved with the generated input vector.

The general process of FIG. 1 can also be extended to the generation of test vectors for transition faults. In the case of transition faults, however, there are two input vectors for each fault that is being tested. A transition fault occurs when a node was at first logic state (0 or 1) and was supposed to flip to a different logic state (1 or 0) in the next cycle, and fails to do so. In the case of a “slow to rise” transition fault, a node that was supposed to originate with a 0 and flip to a 1 in the next cycle fails to do so and instead latches to a 0 on next cycle. Similarly, in the case of a “slow to fall” transition fault, a node that was supposed to originate with a 1 and flip to a 0 in the next cycle fails to do so and latches to a 1 on the next cycle.

In an embodiment, to test for transition faults there is a first “unprimed” input vector whose purpose is to establish the circuit state such that the node under test is set to its correct original value (0 in the case of slow to rise and 1 in the case of slow to fall). The unprimed input vector is then followed by a second “primed” input vector whose purpose is to reveal the existence of the fault should it exist. Thus, testing for a transition fault includes first presenting the unprimed input vector to the circuit and then presenting the primed input vector to the circuit.

In theory, the same approach taken above with respect to Eqn. 1 can be taken for transition faults except that there are two f*(v) functions per fault: one for the unprimed vector (call it f*′(v)) and one for the primed vector (call it f*″(v)). The function f*′(v) for the unprimed vector is a logical expression for the circuit that corresponds to the operation of the circuit when it sets the node under test to the correct value (“0” in the case of slow to rise and “1” in the case of slow to fall). Thus, f*′(v) is an expression describing the logical operation of the circuit when it should excite the node under test to the appropriate value. That is, f*′(v) provides the output of the circuit during a cycle at which the node under test is being set to the appropriate value.

The second function f*″(v) is handled no differently than the “stuck at” function f*(v) discussed above with respect to Eqn. 1. That is, f*″(v) describes the operation of the circuit when the node under test failed to flip on the next cycle, which, mathematically, is the same as the node having been stuck at the value it was set to. As such, another fault equation of the form:

Pₖ(v)=(f₁*′(v)OR f2*′(v)OR f3*′(v) . . . fm*′(v))AND ((f₁(v)XOR f₁*″(v))OR(f2(v)XOR f2*″(v))OR . . . (fₙ(v)XOR fₙ*″(v)) Eqn. 3,

(assuming there are m functions that can excite the fault at the fault location) can be expressed for a transition fault at a particular node where f(v) represents expressions that describe the operation of the circuit as designed. Note that Eqn. 3 represents a particular type of fault (e.g., slow to rise or slow to fail) at a particular node. The number of instances of equations of the form of Eqn. 3 to cover a circuit for transitional faults may therefore be 2z where z is the number of nodes in the circuit (assuming that every node in the circuit could experience both types of transition fault).

Note that the size of vector v in Eqn. 3 is larger than the vector v in Eqn. 1. That is, vector v of Eqn. 1 has a size of n and vector v of Eqn. 3 has a size of m+n. As written, the “left half” of vector v for Eqn. 3 can be viewed as the unprimed input vector and the “right half” of vector v for Eqn. 3 can be viewed as the primed input vector.

The remainder of the design flow as presented in FIG. 1 can then be followed with the output being a set of vectors having size 2n one half of which corresponds to the unprimed input vector and the other half corresponds to the primed input vector.

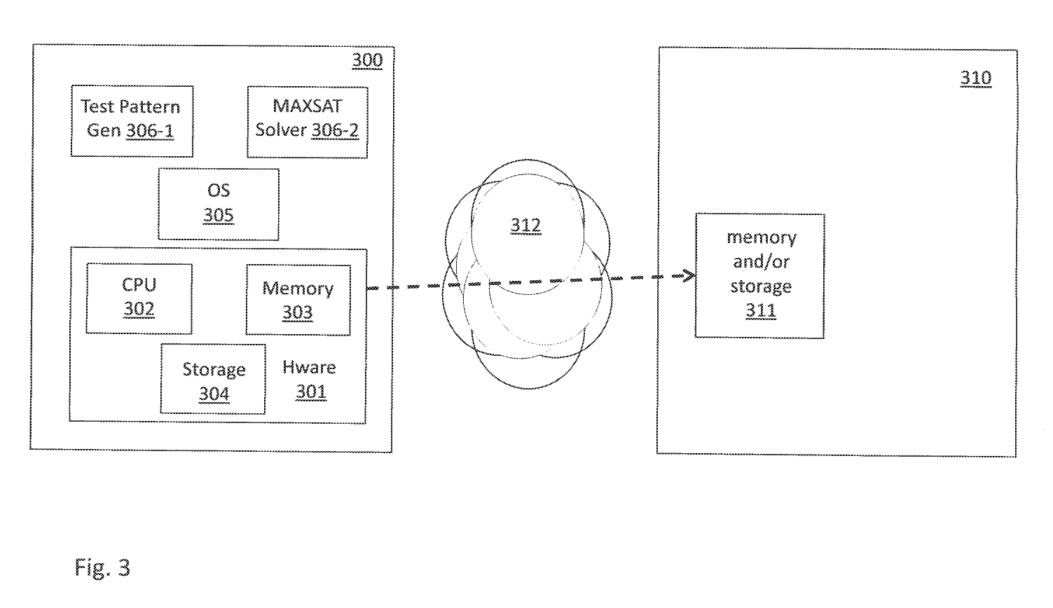

FIG. 3 shows a computing environment 300 that can be used to implement the teachings provided herein. The computing environment may be implemented with a computer such as a server or workstation computer. Here, a hardware computing platform 301 is shown having a CPU (e.g., one or more processors) 302, memory 303 and storage resources 304. An operating system 305 and application software 306-1, 306-2 runs on the hardware platform 301. The application software includes an automatic test pattern generator 306-1 that receives a gate level netlist of a circuit as an input (which in typical cases is provided from memory 303 and/or storage resources 304). A (e.g., commercially available) MAXSAT problem solver 306-2 is also another application software program that exists within the environment 300.

The automatic test pattern generator application software program 306-1 is essentially program code that has been written to effect the methodology of FIG. 1 with the exception of the MAXSAT problem solving processes which are handled by the MAXSAT problem solver 306-2. As such, for example, the test pattern generator application software program 306-1 may make a function call to the MAXSAT problem solver 306-2 after program 306-1 has posed the fault problems to be solved. After the MAXSAT problem solver 306-2 provides its results the test vector generation application software program 306-1 continues forward with the operation of the methodology of FIG. 1.

As discussed above with respect to FIG. 1, the output of the test pattern generation application software program 306-1 with each iteration is a test pattern that may be stored in memory 303 and/or storage 304. Upon completion of the test pattern generation program 306-1, memory 303 and/or storage 304 may contain a set of test patterns for the circuit and information describing nodes where test points need to be inserted. Circuit designers may then modify the gate level netlist to include the test points and manufacture the circuit design into a semiconductor chip.

The semiconductor chip may then be loaded into the memory and/or storage resources 311 of a semiconductor chip tester 310 which receives receives the set of test patterns from a network 311 that the semiconductor chip tester and the computing system having the environment 300 are coupled to. The semiconductor chip tester 310 may then test the chip with the input test vectors and compare the circuits output against the associated output vectors that were received with the input test vectors.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Embodiments of the invention may also be implemented as an electronic circuit design such as an electronic circuit design expressed in any of high level description language (e.g., VHDL or Verilog) description, a register transfer list (RTL) description or netlist, a gate level netlist or a transistor level netlist. Although the above embodiments principally described the design approach in relation to a gate level netlist, other embodiments may extend the teachings herein to other forms of circuit description.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
performing the following by executing program code on a computing system:
generating an expression describing the operation of an electronic circuit for each of a plurality of stuck-at faults within the circuit;
generating a plurality of fault equations for each of the faults that compare output bits of a faulty circuit with output bits of a working circuit; and,
combining the fault equations into a conjunctive logical expression;
attempting to solve a problem posed by the conjunctive logical expression with a MAXSAT solver tool to generate a test vector for the electronic circuit.

2. The method of claim 1 wherein the faults include a stuck-at-0 fault and a stuck-at-1 fault for each of a plurality of nodes within the circuit.

3. The method of claim 1 wherein the faults include fail-to-rise and fail-to-fall faults for each of a plurality of nodes within the circuit.

4. The method of claim 1 wherein the method further comprises:
after the attempting, combining fault equations that the test vector failed to generate a true condition for into a second conjunctive logical expression;
attempting to solve a second problem posed by the conjunctive logical expression with the MAXSAT solver to generate a second test vector for the electronic circuit.

5. The method of claim 4 wherein the method further comprises:
upon the MAXSAT solver failing to generate an input vector for the circuit that sets at least one conjunctive term to true in a conjunctive logical expression that no previous test vector could set to true, inserting test points into a design of the electronic circuit so that the nodes that the terms correspond to are explicitly testable.

6. The method of claim 1 wherein the method further comprises:
upon the MAXSAT solver failing to generate an input vector for the circuit that sets at least one conjunctive term to true in a conjunctive logical expression that no previous test vector could set to true, inserting test points into a design of the electronic circuit so that the nodes that the terms correspond to are explicitly testable.

7. The method of claim 1 wherein the method further comprises saving a set of test vectors for the circuit.

8. The method of claim 7 further comprising sending the test vectors to a semiconductor chip tester and testing a chip having the electronic circuit with the test vectors.

9. A machine readable medium having stored thereon program code that when processed by a central processing unit of a computing system cause a method to be performed, the method comprising:
generating an expression describing the operation of an electronic circuit for each of a plurality of stuck-at faults within the circuit;
generating a plurality of fault equations for each of the faults that compare output bits of a faulty circuit with output bits of a working circuit; and,
combining the fault equations into a conjunctive logical expression;
attempting to solve a problem posed by the conjunctive logical expression with a MAXSAT solver tool to generate a test vector for the electronic circuit.

10. The machine readable medium of claim 9 wherein the faults include a stuck-at-0 fault and a stuck-at-1 fault for each of a plurality of nodes within the circuit.

11. The machine readable medium of claim 9 wherein the faults include fail-to-rise and fail-to-fall faults for each of a plurality of nodes within the circuit.

12. The machine readable medium of claim 9 wherein the method further comprises:
after the attempting, combining fault equations that the test vector failed to generate a true condition for into a second conjunctive logical expression;
attempting to solve a second problem posed by the conjunctive logical expression with the MAXSAT solver to generate a second test vector for the electronic circuit.

13. The machine readable medium of claim 12 wherein the method further comprises:
upon the MAXSAT solver failing to generate an input vector for the circuit that sets at least one conjunctive term to true that no previous test vector could set to true, inserting test points into a design of the electronic circuit so that the nodes that the terms correspond to are explicitly testable.

14. The machine readable medium of claim 9 wherein the method further comprises:
upon the MAXSAT solver failing to generate an input vector for the circuit that sets at least one conjunctive term to true that no previous test vector could set to true, inserting test points into a design of the electronic circuit so that the nodes that the terms correspond to are explicitly testable.

15. The machine readable medium of claim 9 wherein the method further comprises saving a set of test vectors for the circuit.

16. The machine readable medium of claim 15 further comprising sending the test vectors to a semiconductor chip tester and testing a chip having the electronic circuit with the test vectors.

17. A computing system, comprising:
a central processing unit;
memory coupled to the central processing unit, the memory containing program code that when processed by the central processing unit causes a method to be performed, the method comprising:
generating an expression describing the operation of an electronic circuit for each of a plurality of stuck-at faults within the circuit;
generating a plurality of fault equations for each of the faults that compare output bits of a faulty circuit with output bits of a working circuit; and, combining the fault equations into a conjunctive logical expression;
attempting to solve a problem posed by the conjunctive logical expression with a MAXSAT solver tool to generate a test vector for the electronic circuit.

18. The computing system of claim 17 wherein the faults include any of:
a stuck-at-0 fault for each of a plurality of nodes within the circuit;
a stuck-at-1 fault for each of a plurality of nodes within the circuit;
a fail-to-rise fault for each of a plurality of nodes within the circuit;
a fail-to-fall fault for each of a plurality of nodes within the circuit.

19. The computing system of claim 17 wherein the method further comprises:
after the attempting, combining fault equations that the test vector failed to generate a true condition for into a second conjunctive logical expression;
attempting to solve a second problem posed by the conjunctive logical expression with the MAXSAT solver to generate a second test vector for the electronic circuit.

20. The computing system of claim 17 wherein the method further comprises:
upon the MAXSAT solver failing to generate an input vector for the circuit that sets at least one conjunctive term to true that no previous test vector could set to true, inserting test points into a design of the electronic circuit so that the nodes that the terms correspond to are explicitly testable.
